(19) United States
(12) Patent Application Publication
(10) Pub. No.: US 2026/0288367 A1
(43) Pub. Date: Sep. 24, 2026

(54) RANK SELECT LOGIC FOR A MEMORY SYSTEM

(71) Applicant: Micron Technology, Inc., Boise, ID (US)

(72) Inventors: Gang Zhao, Boise, ID (US); Aparna U. Limaye, Boise, ID (US); Ataul Karim, Boise, ID (US); Soham Bhattacharjee, Baruipur (IN); Sumeet Mathur, Bangalore (IN); Chihching Chen, Milpitas, CA (US)

(21) Appl. No.: 19/569,656

(22) Filed: Mar. 17, 2026

Related U.S. Application Data
(60) Provisional application No. 63/774,231, filed on Mar. 19, 2025.

(51) Int. Cl. G06F 3/06

(52) U.S. Cl. CPC G06F 3/0655; G06F 3/061; G06F 3/0673

(57) ABSTRACT

A memory system can include a plurality of memory devices accessible as a plurality ranks and rank select logic. The rank select logic can be coupled to the plurality of memory devices. The rank select logic receives a plurality of data signals from a host via a data bus. The rank select logic can also couple the plurality data lines to the memory devices of a selected one of the plurality of ranks while preventing data signals from being provided to the memory devices of unselected ranks.

### PRIORITY INFORMATION

This Application claims the benefit of U.S. Provisional Application Number 63/774,231, filed on Mar. 19, 2025, the contents of which are incorporated herein by reference.

### TECHNICAL FIELD

Embodiments of the disclosure relate generally to memory systems, and more specifically, relate to implementing rank select logic for a memory system.

### BACKGROUND

A memory system can include one or more memory devices that store data. The memory devices can be, for example, non-volatile memory devices and volatile memory devices. In general, a host system can utilize a memory system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory system in accordance with some embodiments of the present disclosure.

FIG. 2 is a block diagram corresponding to a rank select logic in accordance with some embodiments of the present disclosure.

FIG. 3 is a block diagram corresponding to a coupling of a memory system to a host using a rank select logic in accordance with some embodiments of the present disclosure.

FIG. 4 is a block diagram of a rank select logic and a stack of memory devices in accordance with some embodiments of the present disclosure.

FIG. 5 is a block diagram of memory system comprising a first rank select logic and a second rank select logic in accordance with some embodiments of the present disclosure.

FIG. 6 is a timing diagram of the use of data lines in accordance with some embodiments of the present disclosure.

FIG. 7 is a flow diagram corresponding to a method for implementing a rank select logic in accordance with some embodiments of the present disclosure.

FIG. 8 is a block diagram of an example computer system in which embodiments of the present disclosure may operate.

### DETAILED DESCRIPTION

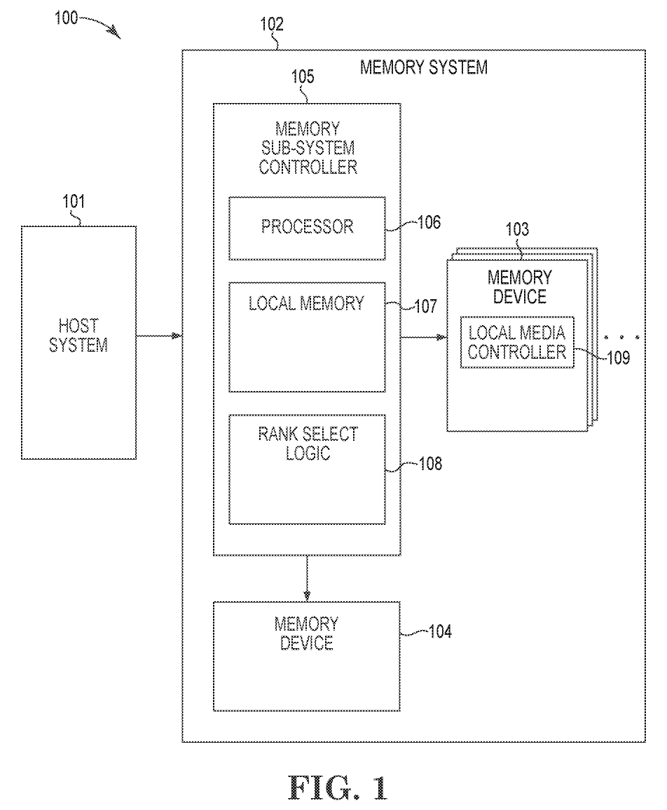

Aspects of the present disclosure are directed to implementing rank select logic for a memory system. A memory system can be a storage system, storage device, a memory module, or a combination of such. Examples of memory systems include a dual in-line memory module (DIMM) or a solid-state drive (SSD). Further examples of storage devices and memory modules are described below in conjunction with FIG. 1, et alibi. In general, a host system can utilize a memory system that includes one or more components, such as memory devices that store data. The host system can provide data to be stored at the memory system and can request data to be retrieved from the memory system. The memory system can include a plurality of ranks of memory devices. The memory system can include rank select logic to provide data from the host to one or more of the plurality of ranks and/or to provide data from the one or more of the plurality of ranks to the host.

In previous examples, memory systems may target 14.4 gigabytes (Gbps) of data speed performance. However, input/output (IO) speeds for 4 rank memory systems can be limited to 6.4 Gbps. The 4 rank memory systems can be limited to 6.4 Gbps of IO speeds which can be primarily due to the heavy capacitive loading of a data bus coupling a host to a memory system. The heavy capacitive load on the data bus can be due to the concurrent coupling of the host data bus to multiple ranks of memory devices (e.g., low-power double-data rate (LPDDR) devices). For example, prior approaches involve the host data bus being coupled to multiple ranks (e.g., multiple memory devices), with each rank having a corresponding respective terminal (e.g., pin or pad) contributing an increased capacitive load on the host data bus, with the increased capacitive load resulting in reduced interface speed.

Aspects of the present disclosure address the above and other deficiencies by implementing rank select logic in the memory system to couple a single rank of memory devices to a host at a time. Limiting the quantity of ranks of memory devices that are coupled to the host can reduce the capacitive load on the data bus (e.g., the DQ signal lines) that couples the host to the memory system. Reducing the capacitive load on the DQ bus as seen by the host can increase the associated interface speed.

The rank select logic can include switching circuitry and a decoder. The switching circuitry can couple one or more of the ranks of memory devices to the host based on select signals received from the decoder (e.g., decoder circuitry) of the memory system. The decoder can generate the select signals from the control address (CA) signals, chip select (CS) signals, and/or clock (CK) signals received from a host. Data bus capacitive loading can be reduced by a factor of 4 leading to higher speed performance of the memory system.

FIG. 1 illustrates an example computing system 100 that includes a memory system 102 in accordance with some embodiments of the present disclosure. The memory system 102 can include media, such as one or more volatile memory devices (e.g., memory device 104), one or more non-volatile memory devices (e.g., memory device 103), or a combination of such.

A memory system 102 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

In some embodiments, the host system 101 is coupled to different types of memory system 102. FIG. 1 illustrates one example of a host system 101 coupled to a memory system 102. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 101 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 101 uses the memory system 102, for example, to write data to the memory system 102 and read data from the memory system 102.

The host system 101 can be coupled to the memory system 102 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 101 and the memory system 102. The host system 101 can further utilize an NVM Express (NVMe) interface to access components (e.g., memory devices 103) when the memory system 102 is coupled with the host system 101 by the PCIe interface. The physical host interface can provide an interface for passing control, address, data, clock, and other signals between the memory system 102 and the host system 101. FIG. 1 illustrates a memory system 102 as an example. In general, the host system 101 can access multiple memory systems via a same communication connection, multiple separate communication connections, and/or a combination of communication connections.

The memory devices 103, 104 can include any combination of the different types of non-volatile memory devices and/or volatile memory devices. The volatile memory devices (e.g., memory device 104) can be, but are not limited to, random access memory (RAM), such as dynamic random-access memory (DRAM) and synchronous dynamic random access memory (SDRAM).

Some examples of non-volatile memory devices (e.g., memory device 103) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103, 104 can include one or more arrays of memory cells. One type of memory cell, for example, includes single level cells (SLC) which can store one bit per cell. Other types of memory cells, such as multi-level cells (MLCs), triple level cells (TLCs), quad-level cells (QLCs), and penta-level cells (PLC), can store multiple bits per cell. In some embodiments, each of the memory devices 103 can include one or more arrays of memory cells such as SLCs, MLCs, TLCs, QLCs, or any combination of such. In some embodiments, a particular memory device can include an SLC portion and an MLC portion, a TLC portion, a QLC portion, or a PLC portion of memory cells. The memory cells of the memory devices 103 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 103 can be based on any other type of non-volatile memory or storage device, such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory system controller 105 (or controller 105 for simplicity) can communicate with the memory devices 103 to perform operations such as reading data, writing data, or erasing data at the memory devices 103 and other such operations. The memory system controller 105 can include hardware such as one or more integrated circuits and/or discrete components, a buffer memory, or a combination thereof. The hardware can include digital circuitry with dedicated (i.e., hard-coded) logic to perform the operations described herein. The memory system controller 105 can be a microcontroller, special purpose logic circuitry (e.g., a field programmable gate array (FPGA), an application specific integrated circuit (ASIC), etc.), or other suitable processors.

The memory system controller 105 can include a processor 106 (e.g., a processing device) configured to execute instructions stored in a local memory 107. In the illustrated example, the local memory 107 of the memory system controller 105 includes an embedded memory configured to store instructions for performing various processes, operations, logic flows, and routines that control operation of the memory system 102, including handling communications between the memory system 102 and the host system 101 and/or the test system 101.

In some embodiments, the local memory 107 can include memory registers storing memory pointers, fetched data, etc. The local memory 107 can also include read-only memory (ROM) for storing micro-code. While the example memory system 102 in FIG. 1 has been illustrated as including the memory system controller 105, in another embodiment of the present disclosure, a memory system 102 does not include a memory system controller 105, and can instead rely upon external control (e.g., provided by an external host, or by a processor or controller separate from the memory system).

In general, the memory system controller 105 can receive commands or operations from the host system 101 and can convert the commands or operations into instructions or appropriate commands to achieve the desired access to the memory device 103 and/or the memory device 104. The memory system controller 105 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 103. The memory system controller 105 can further include host interface circuitry to communicate with the host system 101 via the physical host interface. The host interface circuitry can convert the commands received from the host system into command instructions to access the memory device 103 and/or the memory device 104 as well as convert responses associated with the memory device 103 and/or the memory device 104 into information for the host system 101.

The memory system 102 can also include additional circuitry or components that are not illustrated. In some embodiments, the memory system 102 can include a cache or buffer (e.g., DRAM) and address circuitry (e.g., a row decoder and a column decoder) that can receive an address from the memory system controller 105 and decode the address to access the memory device 103 and/or the memory device 104.

In some embodiments, the memory device 103 includes local media controllers 109 that operate in conjunction with memory system controller 105 to execute operations on one or more memory cells of the memory devices 103. An external controller (e.g., memory system controller 105) can externally manage the memory device 103 (e.g., perform media management operations on the memory device 103). In some embodiments, a memory device 103 is a managed memory device, which is a raw memory device combined with a local controller (e.g., local controller 109) for media management within the same memory device package. An example of a managed memory device is a managed NAND (MNAND) device.

The memory system 102 can include rank select logic 108. Although not shown in FIG. 1 so as to not obfuscate the drawings, the rank select logic 108 can include various circuitry to facilitate providing data signals to a rank of memory devices while lowering the capacitive load on the data bus that coupled the host 101 to the memory system 102. In some embodiments, the rank select logic 108 can include special purpose circuitry in the form of an ASIC, FPGA, state machine, and/or other logic circuitry that can allow the rank select logic 108 to orchestrate and/or perform operations to described herein.

In some embodiments, the memory system controller 105 includes at least a portion of the rank select logic 108. For example, the memory system controller 105 can include a processor 106 (processing device) configured to execute instructions stored in local memory 107 for performing the operations described herein. In some embodiments, the rank select logic 108 can be implemented externally to the memory system controller 105 but internal to the memory system 102.

In a non-limiting example, an apparatus (e.g., the computing system 100) can include the rank select logic 108. The rank select logic 108 can be resident on the memory system 102. As used herein, the term “resident on” refers to something that is physically located on a particular component. For example, the rank select logic 108 being “resident on” the memory system 102 refers to a condition in which the hardware circuitry that comprises the rank select logic 108 is physically located on the memory system 102. The term “resident on” can be used interchangeably with other terms such as “deployed on” or “located on,” herein.

In various examples, the rank select logic 108 can be configured to route received data signals to the memory devices 103, 104. The rank select logic 108 can include switching circuitry and decode circuitry. The decode circuitry can decode CA signals, CS signals, and CK signals to generate select signals. The decode circuitry can provide the select signals to the switching circuitry. The switching circuitry can utilize the select signals to select a one or more memory devices in a rank. The switching circuitry can receive data signals from the host system 101 which can also be referred to as a host 101. The switching circuitry can provide the data signals to the selected one or more memory devices in a rank and refrain from providing the data signals to different memory devices in different ranks.

As used herein, providing data signals to one or more memory devices in a rank can include coupling the one or more memory devices in a rank to DQ lines that provided the data signals to the switching circuitry. Refraining from providing the data signals to different memory devices in different ranks can include decoupling and/or refraining from coupling the different memory devices in the different ranks to the DQ lines that provide the data signals to the switching circuitry. Coupling or decoupling the memory devices to DQ lines that provide data signals to the switching circuitry can include coupling or decoupling the memory devices to or from a host that provides data signals to the DQ lines (e.g., DQ bus that couples the host to the memory system).

The examples provided herein are given in the context of storing data in the memory devices. However, the examples described herein can also be applicable to reading data from the memory devices. For instance, the switching circuitry can route data signals received from the memory devices in a rank to the host based on select signals received from the decode circuitry as part of a read command provided by the host.

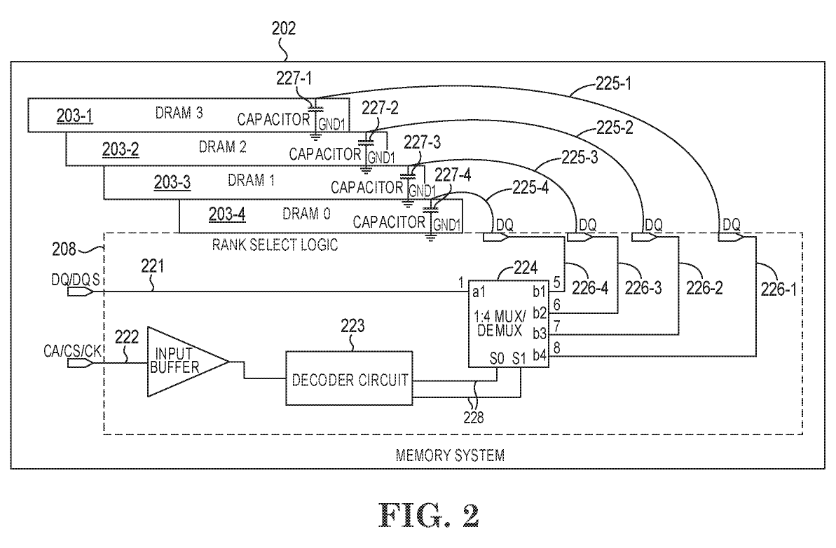

FIG. 2 is a block diagram corresponding to a rank select logic 208 in accordance with some embodiments of the present disclosure. The rank select logic 208 can include switching circuitry 224 and the decoder circuitry 223. The rank select logic 208 can be coupled to a plurality of memory devices 203-1, 203-2, 203-3, 203-4 which are accessible as ranks. The memory devices 203-1, 203-2, 203-3, 203-4 can be referred to as memory devices 203. The rank select logic 208 can also be coupled to DQ lines 221. The DQ lines 221 can be referred to as a DQ bus 221 and can correspond to an interface between the memory system 202 and a host (e.g., the host 101 of FIG. 1).

Although the rank select logic 208 is coupled to the memory devices 203 and the DQ bus 221, the rank selection logic 208 can couple one or more of the memory devices 203 in a rank to the DQ bus 221 at a time utilizing the switching circuitry 224. For example, at a first time, the switching circuitry 224 can couple the memory device 203-1 in a first rank to the DQ bus 221. The switching circuitry 224 can couple the memory device 203-2 in a second rank to the DQ bus 221 at a second time.

The switching circuitry 224 can receive data signals from the DQ bus 221 and select signals 228 from the decoder circuitry 223. The switching circuitry 224 can utilize the select signals 228 to determine where to route the data signals. For example, the switching circuitry 224 can couple the memory device 203-1 in a first rank to the DQ bus 221 based on a received select signal. The switching circuitry 224 can route the data signals to the memory devices 203-1 by coupling the memory device 203-1 to the DQ bus 221.

The coupling of DQ bus 221 to memory devices 203 can include coupling lines 226-1, 226-2, 226-3, 226-4 of the rank select logic 208 to the DQ bus 221. The lines 226-1, 226-2, 226-3, 226-4 can be referred to as lines 226. The lines 226 can couple the rank select logic 208 to the memory devices 203 via the lines 225-1, 225-2, 225-3, 225-4, 225-5, referred to as lines 225. For example, the lines 226-1 can couple the switching circuitry 224 and/or the rank select logic 208 to the memory device 203-1 via the lines 225-1. The lines 226-2 can couple the switching circuitry 224 and/or the rank select logic 208 to the memory device 203-2 via the lines 225-2. The lines 226-3 can couple the switching circuitry 224 and/or the rank select logic 208 to the memory device 203-3 via the lines 225-3. The lines 226-4 can couple the switching circuitry 224 and/or the rank select logic 208 to the memory device 203-4 via the lines 225-4.

The memory devices 203 can be accessed via ranks. The memory devices 203 can be organized in ranks. Each rank of memory devices can be coupled to the DQ bus via the switching circuitry 224. In the example of FIG. 2 each of the memory devices 203 can be in a different rank. The example of FIG. 2 includes four ranks. The memory device 203-1 can be a first rank, the memory device 203-2 can be a second rank, the memory device 203-3 can be a third rank, and the memory device 203-4 can be a fourth rank. Although each of the memory devices 203 is described as a different rank, in other examples each of the ranks can include multiple memory devices. For example, a first rank can include a first memory device and a second memory device. A second rank can include a third memory device and a fourth memory device. A third rank can include a fifth memory device and a sixth memory device. A fourth rank can include a seventh memory device and an eighth memory device. The examples described herein can be applied to more or less ranks and/or more or fewer memory devices 203 than those described herein.

In the example shown in FIG. 2, each of the memory devices 203 includes a respective capacitor 227-1, 227-2, 227-3, 227-4 (referred to collectively as capacitive loads 227), which represents a capacitive load on the DQ bus. The capacitive loads 227 can correspond to respective terminals (e.g., pins or pads) at the end of each data bus. Although, the overall capacitive loads 227-1, 227-2, 227-3, and 227-4 can correspond to a net effect of other circuits (e.g., drivers, receivers, electrostatic discharge (ESD), etc.).

In previous approaches, all four capacitive loads 227 would be populated on the data bus 221 (e.g., with the host). In contrast, various examples described herein isolate the multiple capacitive loads 227 from the host by turning on only one rank (e.g., one memory device 203) at a time such that the data bus 221 with the host sees only a selected one of the capacitive loads 227-1, 227-2, 227-3, and 227-4 at a time. Coupling a single rank of memory devices to the DQ bus 221 can decrease the capacitive load on the DQ bus 221 as seen by a host which can increase signal edge and increase interface speed.

The decoder (e.g., the decoder circuitry) 223 can include decoder circuitry and control logic. The decoder 223 can receive a CA signals, CS signals, and/or CK signals via the lines 222 (e.g., CA lines, CS lines, and/or CK lines) through corresponding buses (e.g., CA bus, CS bus, and CK and/or bus). The decoder 223 can decode the CA signals, the CS signals, and/or the CK signals. The decoded CA signals, the CS signals, and/or the CK signals can be the select signals. The select signals 228 can be provided from the decoder 223 to control the switching circuitry 224. The switching circuitry 224 can utilize the select signals 228 to determine which of the ranks of memory devices 203 to couple to the DQ bus 221.

The switching circuitry 224 can include hardware for coupling the ranks of memory devices 203 to the DQ bus 221. For example, the switching circuitry 224 can include a multiplexer (MUX) and/or a demultiplexer (DEMUX). The DEMUX can be used to couple ranks of memory devices 203 to the DQ bus 221 when data is being provided from the host to the memory devices 203. The MUX can be used to couple ranks of memory devices 203 to the DQ bus 221 when data is being provided from the memory devices 203 to the host.

For example, a DEMUX can be used for write operations while a MUX is used for read operations. The MUX and the DEMUX can be separate circuitry or integrated circuitry. For example, a single circuitry can be used as a MUX in a first case and as a DEMUX in a second case. To perform a write operation, a host can provide CA signals, CS signals, and/or CK signals to the memory system 202. The memory system 202 can receive the CA signals, the CS signals, and/or the CK signals at the decoder circuitry 223. The decoder circuitry 223 can generate a select signal 228 and provide it to the DEMUX. The host can also provide data signals to the memory system via a data bus. The data bus can provide the data signals to the DQ bus 221 via a plurality of pins of the memory system 202. The DQ bus 221 can provide the data signals to the DEMUX. The DEMUX can route the data signals to one or more memory devices in a rank via the lines 225, 226 based on the select signal. For example, the rank can be selected based on the select signal.

To perform a read operation, a host can provide CA signals, CS signals, and/or CK signals to the memory system 202. The memory system 202 can receive the CA signals, the CS signals, and/or the CK signals at the decoder circuitry 223. The decoder circuitry 223 can generate a select signal and provide it to the MUX. One or more memory devices in a rank can provide data signals to the rank select logic 208 using the lines 225. The rank select logic 208 can receive the data signals at the MUX using the lines 226. The MUX can route the data signals to the DQ bus 221 using the select signal. The DQ bus 221 can provide the data signals to the host. In various examples, the CA signals, CS signals, and/or CK signals received by the rank select logic 208 can be stored in an input buffer prior to being provided to the decoder circuitry 223.

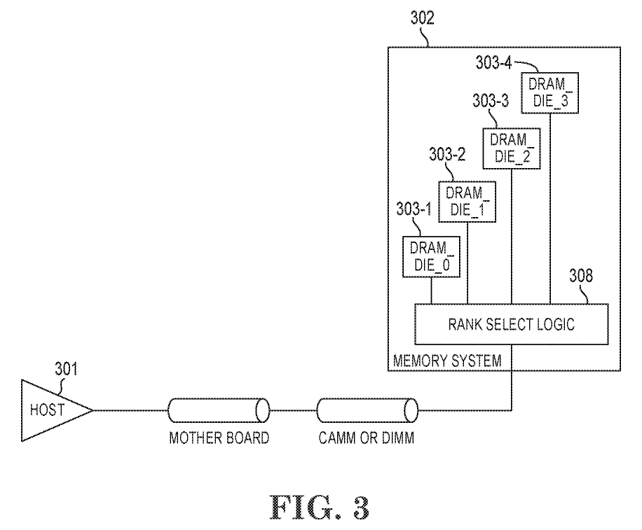

FIG. 3 is a block diagram corresponding to a coupling of a memory system 302 to a host 301 using a rank select logic 308 in accordance with some embodiments of the present disclosure. The memory system 302 is analogous to the memory system 102 and 202 of FIGS. 1 and 2, respectively. The host 301 is analogous to the host 101 of FIG. 1. The rank select logic 308 is analogous to the rank select logic 108 and 208 of FIGS. 1 and 2.

The host 301 can be coupled to one or more memory devices 303-1, 303-2, 303-3, 303-4, referred to as memory devices 303, in a rank via the rank select logic 308. The capacitive load placed on the data bus coupling the host 301 to the memory system 302 can be reduced by coupling one or more memory devices 303 in a rank instead of coupling each of the memory devices 303 to the host 301. The data bus can include lines and/or pins that couple the host 301 to a motherboard, the lines that couple the motherboard to the pins of the memory system 302, and/or lines that couple the pins of the memory system 302 to the memory devices 302.

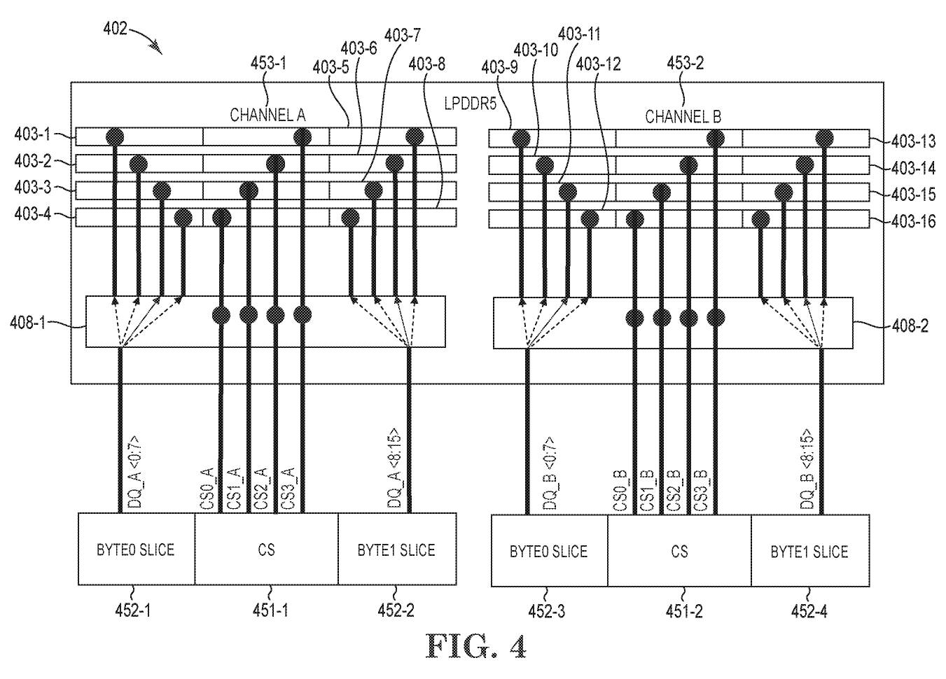

FIG. 4 is a block diagram of memory system 402 comprising a rank select logic 408-1 and a rank select logic 408-2 in accordance with some embodiments of the present disclosure. The rank select logic 408-1, 408-2 can be referred to as rank select logic 408 and are analogous to the rank select logic 108, 208, 308 of FIGS. 1, 2, and 3, respectively. The example shown in FIG. 4 includes a memory system 402 having 2 channels 453-1, 453-2, 8 ranks, and 16 memory devices 403-1, 403-2, 403-3, 403-4, 403-5, 403-6, 403-7, 403-8, 403-9, 403-10, 403-11, 403-12, 403-13, 403-14, 403-15, 403-16, referred to as memory devices 403.

In the example of FIG. 4, a different rank select logic 408 can be implemented for each of the channels 453-1, 453-2. For instance, the rank select logic 408-1 can be implemented for the channel 453-1 while the rank select logic 408-2 is implemented for the channel 453-2. Each of the rank select logic 408 can receive different data signals 452-1, 452-2, 452-3, 452-4. For example, the rank select logic 408-1 can receive the data signals 452-1, 452-2. The rank select logic 408-2 can receive the data signals 451-3, 451-4.

The rank select logic 408 can receive chip select (CS) signals from the host. For example, the decoded CS signals 451-1, 451-2 can be the select signals. The rank select logic 408-1 can receive the decoded CS signals 451-1. The rank select logic 408-2 can receive the decoded CS signals 451-2. The decoded CS signals 451-1, 452-2 can be referred to as decoded CS signals 451. The rank select logic 408 can access the decoded CS signals 451 as the signals are provided to the memory devices 403. The decoder circuitry of the memory system 402 can provide the decoded CS signals 451 to the rank select logic 408 and the memory devices 403.

Each of the 8 ranks of the memory system 402 can correspond to a memory device (e.g., memory dice). For example, the first rank can correspond to the memory devices 403-1, the second rank can correspond to the memory device 403-2, the third rank can correspond to the memory device 403-3, etc.

Each of the rank select logic 408 can couple a rank to DQ lines/data bus that couple the rank select logic 408/memory system 402 to a host. For example, the rank select logic 408-1 can couple any one of the first rank, the second rank, the third rank, and the fourth rank of memory devices 403-1, 403-2, 403-3, 403-4, 403-5, 403-6, 403-7, 403-8 to the DQ lines that provide the data signals 452-1, 452-2. The memory devices 403-1, 403-5 can comprise a first rank that can be selected with the CS0_A signal. The memory devices 403-2, 403-6 can comprise a second rank that can be selected with the CS1_A signal. The memory devices 403-3, 403-7 can comprise a third rank that can be selected with the CS2_A signal. The memory devices 403-4, 403-8 can comprise a fourth rank that can be selected with the CS3_A signal.

The rank select logic 408-2 can couple any one of the fifth rank, the sixth rank, the seventh rank, and the eighth rank of memory devices 403-9, 403-10, 403-11, 403-12, 403-13, 403-14, 403-15, 403-16 to the DQ lines that provide the data signals 452-3, 452-4. The memory devices 403-9, 403-13 can comprise a fifth rank that can be selected with the CS0_B signal. The memory devices 403-10, 403-14 can comprise a sixth rank that can be selected with the CS1_B signal. The memory devices 403-11, 403-15 can comprise a seventh rank that can be selected with the CS2_B signal. The memory devices 403-12, 403-16 can comprise a eighth rank that can be selected with the CS3_B signal.

In various examples, the rank select logic 408-1 can provide data signals 452-1, 452-2 to one of the first rank, the second rank, the third rank, and the fourth rank of memory devices. For example, the rank select logic 408-1 can provide the data signals 452-1 to a memory device 403-1 and the data signals 452-2 to a memory device 403-5 concurrently, where the memory devices 403-1, 403-5 comprise a first rank. The rank select logic 408-2 can provide data signals 452-3, 452-4 to one of the fifth rank, the sixth rank, seventh third rank, and the eighth rank of memory devices.

The rank select logic 408-1 can utilize the CS signals 451-1 to select one of the first four ranks of memory devices. The rank select logic 408-2 can utilize the CS signals 451-2 to select one of the fifth through eighth ranks of memory devices.

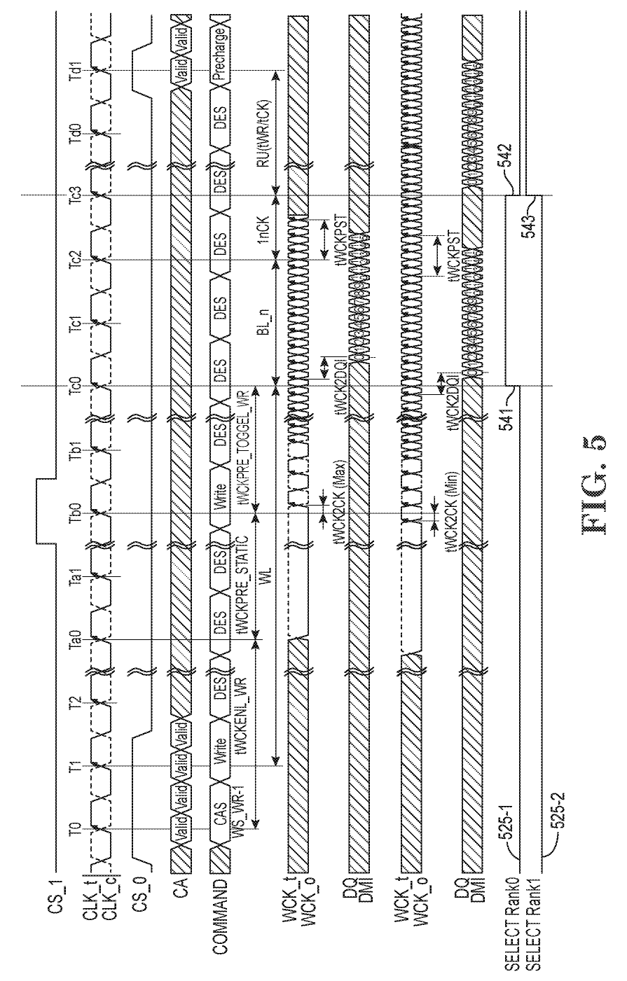

FIG. 5 is a timing diagram of the use of data lines in accordance with some embodiments of the present disclosure. The timing diagram shows data signals being provided to a rank 525-1 of memory devices and data signals being provided to a rank 525-2 of memory devices.

At 541, a rank select logic can provide the data signals to the rank 525-1 of memory devices. At 541, the rank select logic can refrain from providing the data signals to the rank 525-2 of memory devices. At 542, the rank select logic can refrain from providing the data signals to the rank 525-1.

At 543, the rank select logic can provide the data signals to the rank 525-2 of memory devices. At 543, the rank select logic can refrain from providing the data signals to the rank 525-1 of memory devices. The rank select logic can refrain from providing the data signals to the rank 525-1 subsequent to providing the data signals to the rank 525-1 of memory devices. FIG. 5 illustrates that the rank select logic can distribute data signals to one of the ranks at a time.

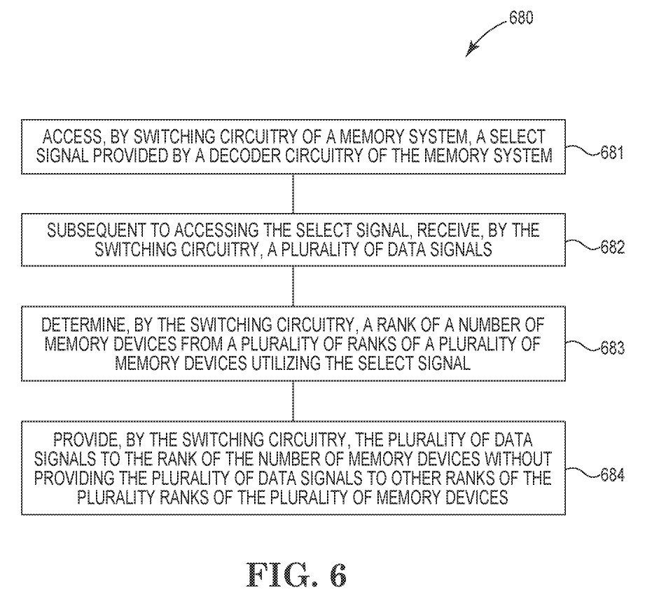

FIG. 6 is a flow diagram corresponding to a method for implementing a rank select logic in accordance with some embodiments of the present disclosure. The method 681 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 680 is performed by the rank select logic 108 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 681, switching circuitry of a memory system can access a select signal provided by a decoder circuitry of the memory system. The switching circuitry can be part of a rank select logic. The switching circuitry can be implemented as a MUX and/or a DEMUX.

At 682, subsequent to accessing the select signal, the switching circuitry can receive a plurality of data signals. The plurality of data signals can be received from a host. The plurality of data signals can be provided by the host to the memory system via a data bus and/or DQ lines.

At 683, the switching circuitry can determine a rank of a number of memory devices from a plurality of ranks of a plurality of memory devices utilizing the select signal. At 684, the switching circuitry can provide the plurality of data signals to the rank of the number of memory devices without providing the plurality of data signals to other ranks of the plurality ranks of the plurality of memory devices.

The switching circuitry can couple data lines corresponding to the number of memory devices to data lines that provide the data signals to the switching circuitry to provide the plurality of data signals to the rank of the number of memory devices. The switching circuitry can refrain from coupling data lines corresponding to the other ranks to data lines that provide the data signals to the switching circuitry. A rank of memory devices can be defined as memory devices that share a chip select.

The switching circuitry can access a different select signal provided by the decoder circuitry subsequent to accessing the select signal. Subsequent to accessing the different select signal, the switching circuitry can receive a different plurality of data signals. The switching circuitry can determine a different rank of a different number of memory devices utilizing the different select signal. The switching circuitry can provide the different plurality of data signals to the different rank of the different number of memory devices and not the rank of the number of memory devices.

In various examples, an apparatus can comprise a plurality of memory devices accessible as a plurality ranks. The apparatus can also comprise rank select logic coupled to the plurality of memory devices. The rank select logic can receive a plurality of data signals from a host via a data bus. The rank select logic can couple the plurality data lines to the memory devices of a selected one of the plurality of ranks while preventing data signals from being provided to the memory devices of unselected ranks.

The rank select logic can comprise switching circuitry configured to receive the plurality of data signals from the host via the data bus. The rank select logic can comprise decode circuitry configured to receive command and address signals from the host via a bus separate from the data bus. The decode circuitry can provide a number of select signals to the switching circuitry based on the received command and address signals. The switching circuitry can determine the selected one of the plurality of ranks based on the number of select signals. The apparatus can comprise a memory package. The plurality of memory devices can comprise a stack of DRAM dies. The rank select logic can comprise a distinct integrated circuit. The integrated circuit of the rank select logic can be different from the integrated circuitry of the memory devices and/or the host.

The switching circuitry can comprise a DEMUX configured to route the plurality of data signals. The DEMUX can route the plurality of data signals to the ranks of memory devices based on the select signal. The rank select logic can comprise the switching circuitry configured to lower a capacitive load on the plurality of data lines.

In various examples, an apparatus can comprise decoder circuitry and a plurality of ranks of memory devices. The apparatus can also include rank select logic coupled to the decoder circuitry and the plurality of ranks of memory devices. The apparatus can also comprise switching circuitry. The rank select logic can access a select signal provided by the decoder circuitry to the plurality of ranks of memory devices and provide the select signal to the switching circuitry. The switching circuitry can receive a plurality of data signals from one of the plurality of ranks of memory devices and can receive the select signal from the decoder circuitry. The switching circuitry can also route the plurality of data signals from the one of the plurality of ranks of memory devices to a host utilizing the select signal.

The switching circuitry can also couple data lines that couple the one of the plurality of ranks of memory devices to the switching circuitry to different data lines that couple the switching circuitry to the host. The switching circuitry can also refrain from coupling data lines that couple remaining ranks from the plurality of ranks of memory devices to the switching circuitry to different data lines that couple the switching circuitry to the host. The switching circuitry can receive a different plurality of data signals from the host subsequent to routing the plurality of data signals from the one of the plurality of ranks of memory devices to the host and receive a different select signal from the decoder circuitry. The switching circuitry can route the different plurality of data signals to a different one of the plurality of ranks of memory devices based on the different select signal.

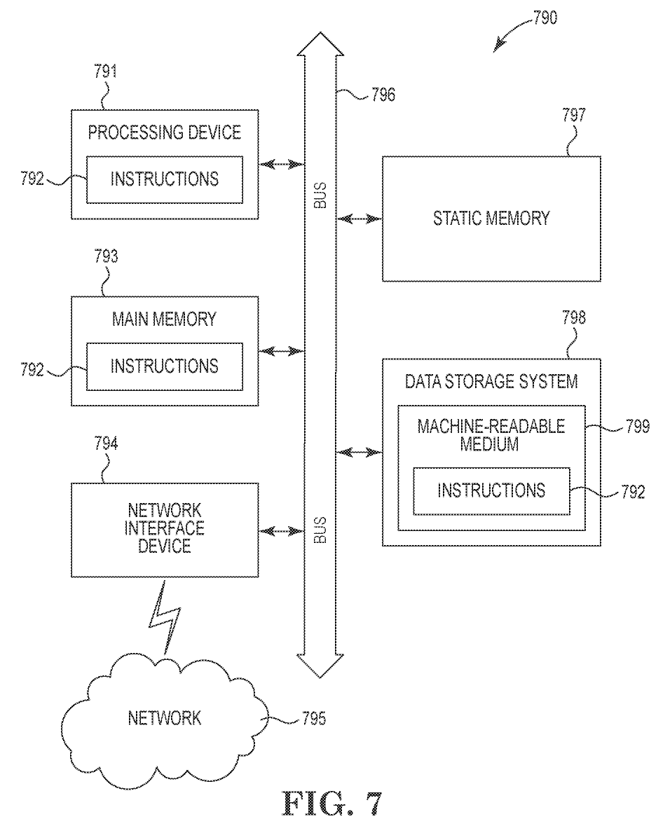

FIG. 7 is a block diagram of an example computer system 700 in which embodiments of the present disclosure may operate. For example, FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 101 of FIG. 1) that includes, is coupled to, or utilizes a memory system (e.g., the memory system 102 of FIG. 1) or can be used to perform the operations of a controller (e.g., to execute an operating system to perform operations corresponding to the rank select logic 108 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

The processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory system 102 of FIG. 1.

In one embodiment, the instructions 726 include instructions to implement functionality corresponding to a rank select logic (e.g., the rank select logic 108 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
a plurality of memory devices accessible as a plurality of ranks;
rank select logic coupled to the plurality of memory devices and configured to:
receive a plurality of data signals from a host via a data bus; and
couple the plurality data lines to the memory devices of a selected one of the plurality of ranks while preventing data signals from being provided to the memory devices of unselected ranks.

2. The apparatus of claim 1, wherein the rank select logic comprises switching circuitry configured to receive the plurality of data signals from the host via the data bus.

3. The apparatus of claim 2, wherein the rank select logic comprises decode circuitry configured to receive command and address signals from the host via a bus separate from the data bus.

4. The apparatus of claim 3, wherein the decode circuitry is configured to provide a number of select signals to the switching circuitry based on the received command and address signals.

5. The apparatus of claim 4, wherein the switching circuitry is configured to determine the selected one of the plurality of ranks based on the number of select signals.

6. The apparatus of claim 4, wherein the apparatus comprises a memory package, and wherein the plurality of memory devices comprises a stack of dynamic random access memory (DRAM) dies.

7. The apparatus of claim 6, wherein the rank select logic comprises a distinct integrated circuit.

8. The apparatus of claim 6, wherein the switching circuitry comprises a demultiplexer (DEMUX) configured to route the plurality of data signals.

9. The apparatus of claim 6, wherein the switching circuitry comprises a multiplexor (MUX) configured to route the plurality of data signals.

10. The apparatus of claim 6, wherein the rank select logic further comprises switching circuitry configured to lower a capacitive load on the plurality of data lines.

11. A method comprising:
accessing, by switching circuitry of a memory system, a select signal provided by a decoder circuitry of the memory system;
subsequent to accessing the select signal, receiving, by the switching circuitry, a plurality of data signals;
determining, by the switching circuitry, a rank of a number of memory devices from a plurality of ranks of a plurality of memory devices utilizing the select signal; and
providing, by the switching circuitry, the plurality of data signals to the rank of the number of memory devices without providing the plurality of data signals to other ranks of the plurality ranks of the plurality of memory devices.

12. The method of claim 11, further comprising coupling, by the switching circuitry, data lines corresponding to the number of memory devices to data lines that provide the data signals to the switching circuitry to provide the plurality of data signals to the rank of the number of memory devices.

13. The method of claim 11, further comprising refrain from coupling, by the switching circuitry, data lines corresponding to the other ranks to data lines that provide the data signals to the switching circuitry.

14. The method of claim 11, wherein the rank of the number of memory devices share a chip select.

15. The method of claim 11, further comprising:
accessing, by the switching circuitry, a different select signal provided by the decoder circuitry subsequent to accessing the select signal;
subsequent to accessing the different select signal, receiving, by the switching circuitry, a different plurality of data signals;
determining, by the switching circuitry, a different rank of a different number of memory devices utilizing the different select signal; and
providing, by the switching circuitry, the different plurality of data signals to the different rank of the different number of memory devices and not the rank of the number of memory devices.

16. An apparatus comprising:
decoder circuitry;
a plurality of ranks of memory devices;
rank select logic coupled to the decoder circuitry and the plurality of ranks of memory devices and comprising switching circuitry;
wherein the rank select logic is configured to:
access a select signal provided by the decoder circuitry;
provide the select signal to the switching circuitry;
wherein the switching circuitry is configured to:
receive a plurality of data signals from one of the plurality of ranks of memory devices;
receive the select signal from the decoder circuitry; and
route the plurality of data signals from the one of the plurality of ranks of memory devices to a host utilizing the select signal.

17. The apparatus of claim 16, wherein the switching circuitry is further configured to couple data lines that couple the one of the plurality of ranks of memory devices to the switching circuitry to different data lines that couple the switching circuitry to the host.

18. The apparatus of claim 16, wherein the switching circuitry is further configured to refrain from coupling data lines that couple remaining ranks from the plurality of ranks of memory devices to the switching circuitry to different data lines that couple the switching circuitry to the host.

19. The apparatus of claim 16, wherein the switching circuitry is further configured to:
receive a different plurality of data signals from the host subsequent to routing the plurality of data signals from the one of the plurality of ranks of memory devices to the host; and
receive a different select signal from the decoder circuitry.

20. The apparatus of claims claim 19, wherein the switching circuitry is further configured to route the different plurality of data signals to a different one of the plurality of ranks of memory devices based on the different select signal.
